(19) United States
(12) Patent Application Publication
(10) Pub. No.: US 2021/0289854 A1
(43) Pub. Date: Sep. 23, 2021

(54) Individual nano-bodies protection of skin and respiratory system

(71) Applicants: Ioana Livia Popa-Simil, Ann Arbor, MI (US); Victor Popa-Simil, Los Alamos, NM (US); Andrei Popa-Simil, Los Alamos, NM (US)

(72) Inventors: Ioana Livia Popa-Simil, Ann Arbor, MI (US); Victor Popa-Simil, Los Alamos, NM (US); Andrei Popa-Simil, Los Alamos, NM (US)

(73) Assignee: LAVM LLC, Los Alamos, NM (US)

(21) Appl. No.: 16/823,242

(22) Filed: Mar. 18, 2020

(51) Int. Cl. A41D 13/12; A41D 13/11; A41D 31/30; A62B 9/00; A62B 18/08; A62B 18/02

(52) U.S. Cl. CPC A41D 13/1218; A41D 13/1263; A41D 13/1281; A41D 13/1153; A62B 18/02; A41D 31/30; A62B 9/003; A62B 18/08; A41D 13/1192

(57) ABSTRACT

During national crisis as virus pandemics, bio-terrorism, chemical pollution, a response is to lock down all the economy, with several % GDP loss, or to convince population to wear, reasonably, appropriate individual anti-virus and bacterial protection accessories, made of a full head and shoulders protection mask, equipped with air ventilation and processing unit, and gloves, and body protection foil, for single or multiple use, and get minimal economic losses. The air processing unit may be developed a modular structure, starting from a simple filtered fan, with air suction on top of the head, flowing air over the face, for low probability of contamination environments, upgraded to a more complex unit including heat pipe, catalytic organic matter reduction, oxygen generator and closed circuit breathing unit, that may be integrated into a full body personal protection equipment by extending the functions of temperature, humidity and pressure control to full body, for hazardous environments.

During national crisis as virus pandemics, bio-terrorism, chemical pollution, a response is to lock down all the economy, with several % GDP loss, or to convince population to wear, reasonably, appropriate individual anti-virus and bacterial protection accessories, made of a full head and shoulders protection mask, equipped with air ventilation and processing unit, and gloves, and body protection foil, for single or multiple use, and get minimal economic losses.

The air processing unit may be developed a modular structure, starting from a simple filtered fan, with air suction on top of the head, flowing air over the face, for low probability of contamination environments, upgraded to a more complex unit including heat pipe, catalytic organic matter reduction, oxygen generator and closed circuit breathing unit, that may be integrated into a full body personal protection equipment by extending the functions of temperature, humidity and pressure control to full body, for hazardous environments.

### STATEMENT REGARDING FEDERALLY SPONSORED R&D

This invention was made with NO Government support.

Free to be used and applied by any entity state or federal entity for local and national emergencies.

### NAMES OF PARTIES TOA JOINT RESEARCH AGREEMENT

This work was part of research of the mentioned inventors.

### CROSS REFERENCE TO RELATED APPLICATIONS

This application claims no priority.

### BACKGROUND OF THE INVENTION

### 1. Field of the Invention

The present invention relates to a scalable method and device for individual protection in moderate bio-hazardous environments, as CoVID-19, SARS, etc., with low but unknown exposure probability.

The presented technology is designed to improve the protection probability in crowded public environments where viral agents' presence is probable and unknown, and where the catual protection based on N95 or surgical masks is inappropriate, and failed to protect, against a particle that is 50 times smaller than its smallest air holes, and simply because this corona virus, diffuses through human skin, into cellular vein blood stream, stopping in lungs alveoli. Simply, if touches any skin surface, hand, face, neck, leg, etc., it contaminates.

The invention seeks to improve the actual method, by improving the quality of individual protection, in the light of new understanding of modern viruses' capabilities of diffusing through human skin if in contact with a liquid expectoration from an infected person, no matter where it is placed on the receiver's skin surface (face, neck, hand, leg, etc.).

The protection system is modular, starts from a simple, cheap structure, easy to made, and develops respirator capabilities making it compatible with the most hazardous environments, where full body ppe (personal protective equipment) is recommended.

The system consists in a variety of head mask and gloves, and several modular devices for air processing and electronic control with patient main bio-medical parameters monitoring. In the most complex cases the air preparation unit, that includes body exhaust gas collection unit, with organics removal, in a catalytic burner and carbon sequestration unit, and air concentration, pressure, humidity and pressure preparation unit, makes the shield even usable in explosive environment, oxygen depleted environments as fires, and more. At a lower end it was designed as single use, cheap, modular individual protection using chemical shielding for bacteria.

It also requires a reasonable method of using it, with respect to dressing and undressing, storage or disposing in safe environments to avoid contamination, or wearing and in challenging conditions as wind, rain or snow. For example, after wearing in presumed hazardous environment, and deciding not to dispose the protective head gaunt one must assure that there is no virus alive and dry on the protective surface, by exposing the surface to a steam or UV shower, than take off the protection gently, and deposit in a collection box, with inner surface protected not to enter in contact to any other potentially contaminated surface. To avoid this hassle one simply may trash the suit, in a safe manner.

### 2. Description of the Prior Art

There are known a large variety of protective suits and masks, from the most simple but inefficient solutions as surgical and N95 masks, to complete ppe-s for highly hazardous environments, most of them known under generic name of disposable gaunt.

Hazards exist in every workplace in many different forms: sharp edges, falling objects, flying sparks, chemicals, noise and a myriad of other potentially dangerous situations. The Occupational Safety and Health Administration (OSHA) requires that employers protect their employees from workplace hazards that can cause injury.

When engineering, work practice and administrative controls are not feasible or do not provide sufficient protection, employers must provide personal protective equipment (PPE) to their employees and ensure its use. Personal protective equipment, commonly referred to as “PPE”, is equipment worn to minimize exposure to a variety of hazards. Examples of PPE include such items as gloves, foot and eye protection, protective hearing devices (earplugs, muffs) hard hats, respirators and full body suits.

It is well known that particulate filters are rated by the National Institute of Occupational Safety and Health according to what, and how much, they filter out. The rating has both a letter and number:

Dust mask for cutting grass.

N: Not oil-proof

R: Oil resistant (up to 8 hours)

P: Oil-proof (beyond 8 hours)

Number: Particulate filters are rated 95, 97 or 100, which corresponds to the percentage of one-micrometer particles removed during clinical trials.
A 95 rating means that the filter removes 95% of particles from the air.

Filters rated 100 are considered High-Efficiency (HE or HEPA) filters.

Filter media is made up of many crisscrossed fibers layered in random directions. When particles from the working environment enter the RESPA air intake port, the particles are impacted and intercepted onto the filter fibers. These particles are subjected to specific filtration mechanics and are dependent on the size of the particle and airflow velocity.

Here is a list of the filtration mechanics and their respective definitions:
Inertial impaction—Occurs when a particle encounters a filter fiber due to the inertia of the particle.
Example: A large dust particle is unable to change direction of flow due to its inertia, so it impacts the fiber and becomes attached to it.
Interception—Occurs when a particle follows a gas streamline that happens to come in contact with the surface of a fiber.
Example: An intermediate dust particle that readily follows the airflow stream comes in contact with a filter fiber.
Diffusion—Occurs when particles do not follow gas streamlines as readily and are governed by random particle motion (Brownian motion of small particles).
Example: A small particle, such as certain exhaust particles, encounter filter fibers at random.
Electrostatic attraction—Occurs when an electrostatic charge on the filter fibers are present.
Example: Static charge on a fabric creating static cling.

In terms of filtration, the most important filtration mechanics pertaining to everyday use are:
1) Inertial impaction and
2) Interception.

The larger particles that encounter the engine filter tend to impact onto the exterior surface of the filter media. The smaller particles that follow airflow streamlines tend to impact and intercept within the depth of the engine filter media. For smaller particles, the filter fibers act as branches that catch harmful engine contaminants passing through the filter. Thus, when a Cab Air Quality System utilizes a precleaner, such as the RESPA-CF2, HVAC life is extended and down time is reduced as fewer contaminants are reaching the filter. Note: Our MERV 16 filter media has special patented properties that shed most particles.

MERV is an acronym for “Minimum Efficiency Reporting Value”. The MERV rating on an air filter describes its efficiency as a means of reducing the level of 0.3 to 10 micron-sized particles in air which passes through the filter. Higher “MERV” means higher filter efficiency. The purpose of the MERV standard is to permit an “apples to apples” comparison of the filtering efficiency of various air filters.

Air filter efficiency refers to the relative ability of a filter to remove particles of a given size or size range from air passing through the filter. If a filter were 100% efficient, none of the particles in a given size range would escape the filter and air which has passed through such a filter would contain zero particles.

The MERV Efficiency Rating Scale ranges from 1 to 16, with 1 being the lowest efficiency and 16 describing the highest efficiency. The particle size range addressed by the MERV scale is 0.3 to 10 microns. A logical inference is that if an air filter is removing particles down to 0.3-10 microns, it is certainly also at least that efficient at removing larger sized particles.

HEPA air filters are not MERV rated as they exceed the ASHRAE test protocol 52.2 used in determining the MERV ratings. In fact, HEPA air filters are the ONLY mechanical air filters that are tested and certified to meet a specific efficiency at a specific particle size. All HEPA air filters must meet a minimum efficiency of 99.97% at 0.3 microns. ASHRAE or MERV air filters are tested using the Dust Spot tests that incorporate some fine dust, powdered carbon and some cotton linters. The Dust Spot test particle size range is from 0.3 microns to 50 microns in size with an average size of approximately 20 microns in size.

HEPA air filters are tested using DOP, Mineral Oil and other materials that generate a mono-dispersed particle that are all 0.3 microns or smaller in size. In essence, if 10,000 of 0.3 micron sized particles are blown into a HEPA air filter, only 3 particles are allowed to pass through. Thus, you get the 99.97% at 0.3 micron rating. If you were to use the HEPA test on a 95% ASHRAE air filter they would be about 50% efficient on 0.3 micron sized particles once they loaded up with dust. So, HEPA air filters are at least 50% more effective at removing respirable sized airborne particles than any of the ASHRAE air filters previously available on the market.

Recommended for uses where airborne contaminants place operator at risk, including contaminants such as Beryllium, DPM (Diesel Particulate Matter), and RCS (Respirable Crystalline Silica). We highly recommend this filter as it represents the best mix of high efficiency filtration and economy.

HEPA Filter is recommended when the very highest level of filtration is needed, OR where HEPA filters are necessary due to regulatory requirements.

MERV RATING CHART is given for clarification on the subject in order to clarify what filters are appropriate to use and how to use them:

| Standard 52.5 | Dust | | | | |
|---|---|---|---|---|---|
| Minimum | Spot | | Typical Controlled | Typical Applications | Typical Air |
| Efficiency | Efficienc | Arrestance | Contaminant | and Limitations | Filter/Cleaner Type |
| 20 | n/a | n/a | <0.30 pm particle | Cleanrooms | ≥99.999% eff. On .10-.20 |
| | | | size | | Particles |
| 19 | n/a | n/a | Virus (unattached) | Radioactive Materials | Particles |
| 18 | n/a | n/a | Carbon Dust | Pharmaceutical Man | Particulates |
| 17 | n/a | n/a | All Combustion | Carcinogenetic | ≥99.97% eff. On .30 pm |
| 16 | n/a | n/a | .30-1.0 pm Particle | General Surgery | Bag Filter- |
| 15 | >95% | n/a | All Bacteria | Hospital Inpatient | microfine fiberglass or |
| | | | | | synthetic media, 12-36 |
| 14 | 90-95% | >98% | Most Tobacco Smoke | Smoking Lounges | 12 pockets |
| | | | | | Box Filter- Rigid Style |
| | | | | | Filters 6 to 12″ deep m |
| 13 | 89-90% | >98% | Proplet Nuceli | Superior Commercial | lofted or paper media. |
| | | | (Sneeze) | Buildings | |
| 12 | 70-75% | >95% | 1.0-3.0 pm Particle | Superior Residential | Bag Filter- |
| | | | Legionella | | microfine fiberglass or |
| | | | | | synthetic media, 12-36 |
| 11 | 60-65% | >95% | Humidifier Dust | Better Commercial | 12 pockets |
| | | | Lead Dust | | |
| | | | | | Box Filter- Rigid Style |
| | | | | | Filters 6 to 12″ deep m |
| 10 | 50-55% | >95% | Milled Flour | | lofted or paper media. |
| | | | Auto Emissions | Hospital Laboratories | |
| 9 | 40-46% | >90% | Welding Fumes | | |
| 8 | | | | | Pleated Filters- |
| | 30-35% | >90% | 3.0-10.0 pm Particle | Commercial Buildings | extended surface area, |
| | | | Size | | thick with |
| | | | | | cotton-polyester blend |
| | | | Mold Spores | | cardboard frame |
| 7 | 25-30% | >90% | Hair Spray | Better Residential | |
| | | | | | Cartridge Filters- |
| | | | | | viscous coated cube or |
| | | | Fabric Protector | | filters, synthetic media |
| 6 | <20% | 85-90% | Dusting Aids | Industrial Workplace | |
| | | | | | Throwaway- Disposable |
| | | | Cement Dust | | synthetic panel filter. |
| 5 | <20% | 80-85% | Pudding Mix | Paint Booth Inlet | |
| 4 | | | | | Throwaway- Disposable |
| | <20% | 75-80% | >10.0 pm Particle Size | Minimal Filtration | fiberglass or synthetic |
| | | | | | panel filter. |
| | | | Pollen | | |
| 3 | <20% | 70-75% | Dust Mites | Residential | Washable- Aluminum |
| | | | Sanding Dust | | |
| 2 | <20% | 65-70% | Spray Paint Dust | | |
| | | | | | Electrostatic- Self |
| | | | Textile Fibers | Window A/C Units | woven panel filter. |
| 1 | <20% | <65% | Carpet Fibers | | |

This table clarifies the limits of filter usage and it is known that are not operational for viruses that are smaller than 300 nm, in the case of COVID-19 that has 100 nm.

The high costs, of actual face mask, and PPEs, their lack of comfort were the main causes for protection failures on the background of modest knowledge and panic. At low end they rely on face transparent masks and facial masks for breathing, and most of the cases due to lack of appropriate knowledge on the threat agent fail to deliver the desired protection. At upper level of PPE, designed for aggressive environments, due to lack of complex enough technology, they also fail to fully protect.

### SUMMARY OF THE INVENTION

The present invention is about a method to increase the efficiency of protection against airborne viruses, starting from the basic concept of leaving no skin surface uncovered, but it hast to be covered in a comfortable manner to avoid itching and sweat, as reasons for being touched or exposed.

The system relies on a set of protective items, as full head mask, gloves, sitting towel, and leg shields, and are designed for single or short period use, being cheap and changeable.

The head mask, has an air intake through the upper part, via a filter and an exhaust downwards, along the body. The air intake may be developed in several stages, from simply basic, to more complex structures, that may include an electric fan, supplementary filters, acclimatization, by setting the temperature, air catalytic cooling, oxygenation and humidity control, oxygen concentration control, carbon dioxide capture, and facial respiratory mask for closed circuit. An electronic system will monitor all these functions plus measuring the main bio-medical parameters, as temperature, pulse rate, oxygen concentration in blood, breathing rate, flows, lung exchange efficiency, coordinates movement and environment. The main parameters of interest may be displayed outside mask and be integrated with the smart phone applications.

This system also collects and augments the communication system, integrating the coordinate control, generating trajectories, in time, and external air quality, as dust, temperature, humidity and other gases.

The system is a modular open system, and any supplementary required function may be added, or its complexity may be reduced to a minimum necessary.

### BRIEF DESCRIPTION OF THE DRAWINGS

FIG. 1 is a view of the actual virus threat;

FIG. 2 is a simplified view of virus capabilities by penetrating human skin;

FIG. 3 shows microscope view of a filter or porous paper structure;

FIG. 4A a view from front of head mask with chemical shields and top air intake, gloves and pants shield;

FIG. 4B—a view from back of the head mask, chemical shields and respirator;

FIG. 5 describes a head-top modular respirator unit;

FIG. 6 shows a schematic diagram of advanced respirator unit and monitoring electronics.

### FIGURES DETAILS

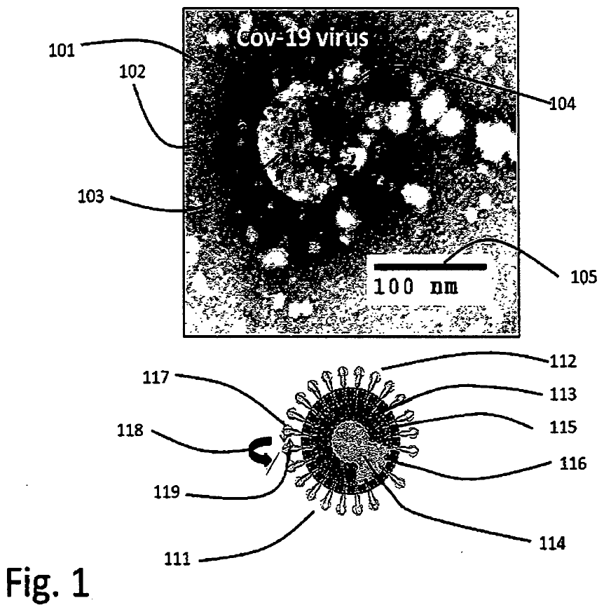

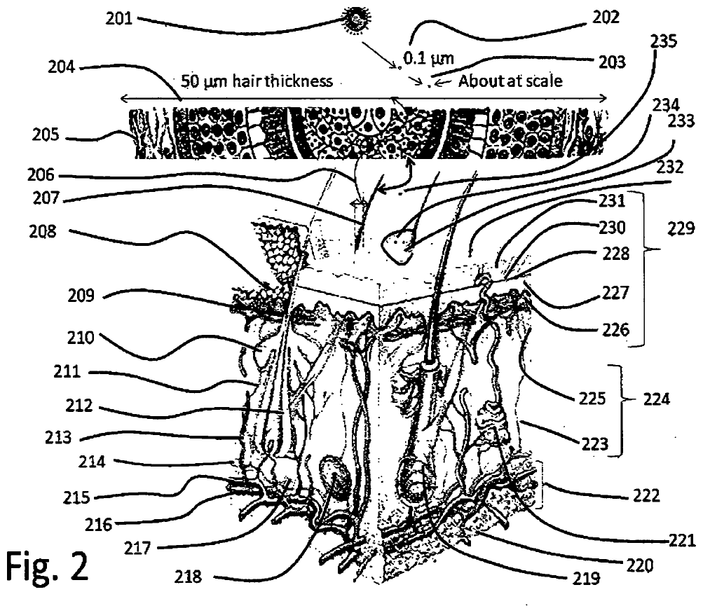

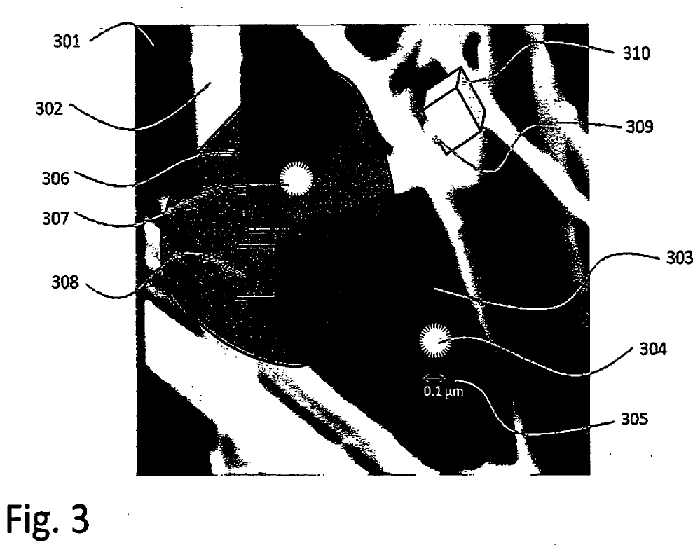

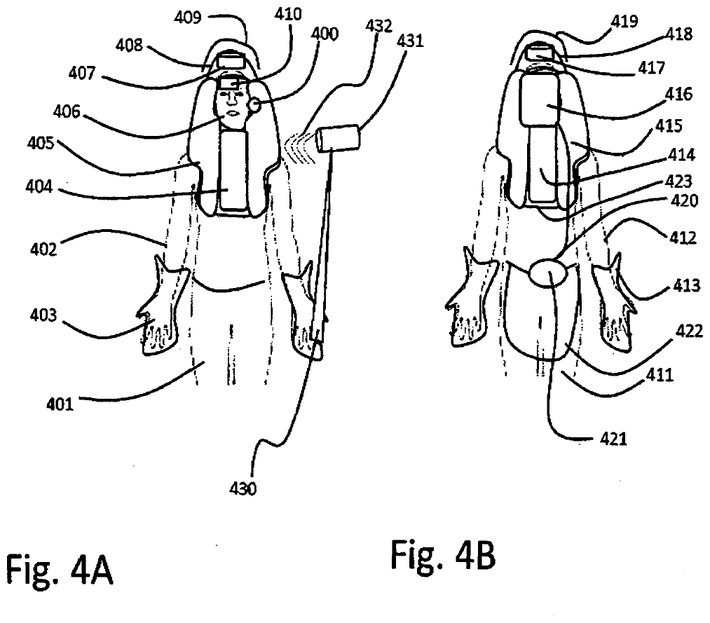

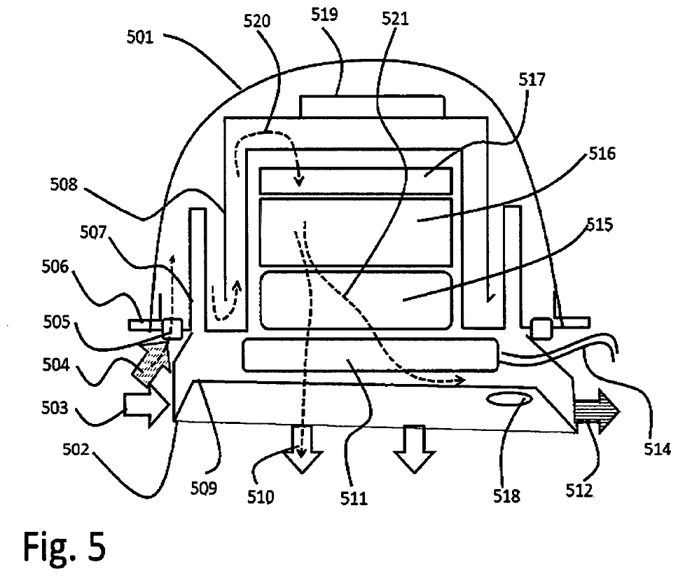

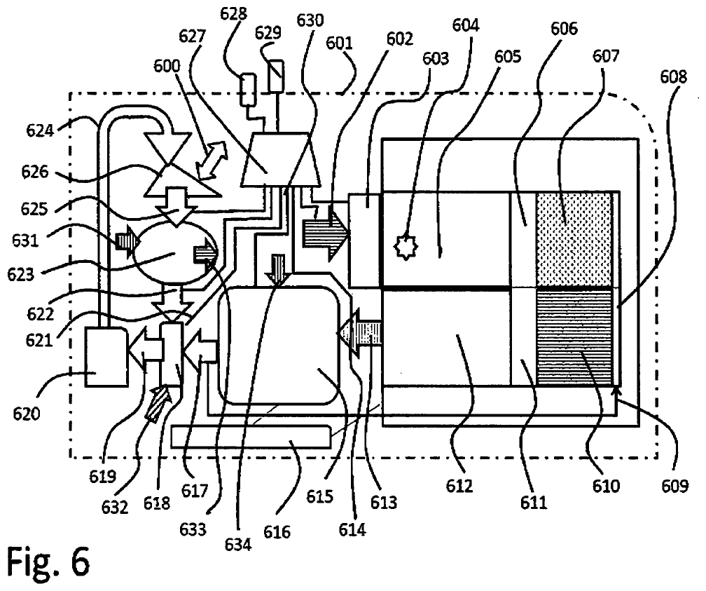

FIG. 1—is a view of the actual virus threat;
101—Electron microscope view of COVID-19 virus;
102—Spikes, glycoprotein trimmer (S);
103—Nucleoprotein (N) and RNA genome;
104—Membrane protein (M)
105—Scale, dimension or PM=0.1 micro-meters;
111—nCoV, SARS, coronavirus schematic diagram;
112—Spikes, glycoprotein trimmer (S);
113—Nucleoprotein (N) and RNA genome;
114—Membrane protein (M);
115—Inside virus shell, genome;
116—Envelope, small membrane protein pentamer €;
117—Moving spike forward;
118—Effective spike movement;
119—Moving spike, inner backwards move.
FIG. 2—A simplified view of virus capabilities by penetrating human skin;
201—CoVID-19 virus, schematics;
202—Attempt to scale to size, compared with a hair;
203—replace of figure with a dot to meet the aspect ratio;
204—Hair shaft diameter;
205—Hair microstructure;
206—Dimension correspondence;
207—Hair shaft;
208—Dermal papillae;
209—Free nerve ending;
210—Sebaceous (oil) gland;
211—Sensory nerve fiber;
212—Arrector pill muscle;
213—Hair follicle;
214—Hair root;
215—Artery;
216—Vein;
217—Meissner's corpuscle;
218—Pacinian corpuscle;
219—Root hair plexus;
220—Adipose tissue;
221—Eccrine sweat gland;
222—Hypodermis (superficial fascia);
223—Reticular layer;
224—Dermis;
225—Papillary layer;
226—Stratum basale;
227—Stratum spinosum;
228—Stratum granulosum;
229—Epidermis;
230—Stratum lucidum;
231—Stratum comeum;
232—Pore;
233—Expectorant droplet;
234—Covid-19 particles;
235—Virus falling on skin.
FIG. 3 shows microscope view of a filter or porous paper structure, and its capabilities of holding
chemicals as salt crystallites bound on its structure
301—N95 microscope image;
302—Celluloid fiber;
303—Empty space among filter fibers;
304—Corona virus particle flying through;
305—Dimension scale;
306—Water droplet with corona virus contamination;
307—Corona virus particle in suspension in water particulate;
308—Salt crystal;
309—Dead corona virus particulate, trapped on salt's surface;
310—Recrystallized salt trapping dead virus corps.
FIG. 4A a view from front of head mask with chemical shields and top air intake, gloves and pants shield;
400—Oxygen, pulse rate, temperature, humidity ear sensor;
401—customer;
402—hand;
403—gloves with chemical shield;
404—Frontal chemical shield;
405—Lateral chemical shield hanged on mask;
406—facial transparent shield;
407—ventilator
408—air filter with chemical stopper;
409—Rain, particulate cover;
410—Forehead electronics box with display and utilities.
430—Articulated selfie stick;
431—IR source, or steam generator;
432—Beam of powerful IR or steam;
FIG. 4B—a view from back of the head mask, chemical shields and respirator;
411—Customer view from behind;
412—Hand;
413—Limited use protective gloves;
414—Air processing box or central back chemical shield;
415—Lateral back protective shields;
416—Portable AC unit;
417—Fan and air input;
418—Air filter with chemical stopper;
419—Cover or hat for rain and particulate protection;
420—Cable connection;
421—Utility and power box;
422—Back chemical and fluid shield;
423—Breathing rate and volume measurement cord.
FIG. 5 describes a head-top modular respirator unit;
501—Head top/hat or helmet;
502—Head contact;
503—Air input for head from an exterior air supply;
504—Air intake flow;
505—Air intake holes;
506—Helmet or head-cover structure;
507—Air labyrinth;
508—Filter upper lid;
509—Air duct lower structure;
510—Airflow washing the face;
511—AC radiator for temperature control;
512—Air flow going out for supplementary external preparation;
514—AC ducts;
515—Fan;
516—HEPA filter;
517—Chemical barrier filter;
518—Electronics measurement;
519—Electronics board, microprocessor and communication;
520—Air flow inside;
521—Air flow towards external air processing;
FIG. 6 shows a schematic diagram of advanced respirator unit and monitoring electronics.
600—Facial respirator (nose-mouth);
601—Air processing unit;
602—Air intake coming from helmet outtake tube;
603—Fan and chemical barrier filter;
604—UV lamp;
605—Heat exchanger, heating path;
606—Input cavity, with electric heat adjustment;
607—Catalytic felt;
608—Oxygenation unit for complete burnout;
609—Oxygen input;
610—Catalytic felt output;
611—Measurement and thermalization unit;
612—Cooling heat exchanger;
613—Gas output;
614—Gas concentrations measurement;
615—PSA Oxygen filter;
616—Power supply;
617—Oxygen enriched output;
618—Breathing gas mixer;
619—Mixer output;
620—Breathing air preparation (p, T; U);
621—Gas parameter measurement and control;
622—Recirculated air exhaust with measurement;
623—Carbon oxides extraction unit;
624—Tube to facial mask;
625—Facial mask exhaust duct;
626—Mouth-nose facial mask;
627—Microprocessor measurement and control unit;
628—Ambient measurement modulus;
629—Customer's bio-medical parameters measurement;
630—Electronic connections.
631—Input from catalytic burner inside carbon sequestration unit;
632—Input from gas/liquid external source or tube;
633—Exit from carbon sequestration unit to oxygen concentrator unit;
634—Input in Oxygen concentrator from carbon sequestration unit

### DETAILED DESCRIPTION OF THE INVENTION

The inventors consider the developments in wearable electronics and bio-medical protection equipment for single use application versus multiple usages, proposing a variety of combinations to meet the criteria for various potential hazard environments. It starts from the principle that customer's skin and interiors must not be visible or in a direct path to any kind of virus or pathogen agent.

The most simple envisioned protection set comes in the form of a huddle, covering the face with a plastic visor, made from absorbent or light paper, impregnated in a saline solid solution with chemical active species that take advantage of the presence of the fluid aerosol accompanying the viruses, that turns it into a local ionic solution, chemically passivating the virus, than sealing it in place by evaporation. A pair or more of single usage gloves made of same material, but having a thin plastic foil sealed towards the hand's face, to prevent against liquid infested surfaces to reach the hand when squeezed and a similar plastic sealed 2 by 2 ft paper towel foul to place on things before sitting or being hanged over the but as a partial rope, protecting the back of the pants while sitting on it.

For more hazardous environments full cloth protection is needed in the form of an impregnated paper single use PPE with some plastic shielded area on interior, that are not the object of the present patent, that may be used as a surrogate PPE for short term visits in a corona-virus treatment facility that is in principle not recommended, because by any incident it is possible to override the limits of use of the surrogate suit and protection to be compromised. It can be done, but the strong advice is to use a real PPE, having in mind that this system have to be operational in crisis time, that the ambient where it is used to have harsh elements exposure.

An important part of the present invention is the respirator system. In less aggressive systems, an air intake on the top of the hoodie like face mask passing via a salt impregnated absorbent paper filter might be enough. The customer has enough room inside and may wear a face mask surgical filter for his/hers piece of mind. In this configuration and colder than dew point environments fog and condensation may occur on the inner side of the visor plastics and a deposition with hydrophobic solution coating might be the cheap alternative, that is not recommended due to chemical hazard, these substances are usually organic solvents with associated volatiles, that might be harmful for long exposures, similar to DEET effects. A transparent ZnO electric deposition with a warming up electric controller and battery is a safer but more expensive solution to the problem. Being a single wear piece of equipment we do not recommend this but we may cover it.

A holistic approach is to use a fan on top pushing an air filtered air flow over the visor area, towards the nose, pushing the exhaled air downwards in the hoodie, and from there out. If the customer wearing the hoodie is sick, a surgical face mask is recommended covered in the protective salty solutions absorbent paper chemical shield, and use chemical shields on inside of the hoodie too.

A more developed approach is to use a helmet or a hard hat structure, that to be covered by the hoodie, and to contain inside a vortex particulate filter, a chemical shield, an active charcoal filter and a heap filter. Care have to be taken that vortex particulate filter to contain chemical shield also, and not dry the aerosols, leaving alone the virus float dry in air, because when dry it will not be stopped by chemical shield and at 100 nm passes through all the filters, turning this generally good feature into a vulnerability. A wet basic chemical filter is recommended, but difficult to wear such a thing on the head.

In its simple form the fan is under a filter, may be a face mask filter, pushing air via few ducts from above the eyes towards mouth and nose. A battery and electronic flow regulator may be added, being supported on an elastic heat like fixture. On this a electronic box holding the oxygen-meter and pulse rate, to be attached on an ear clip, and a temperature sensor inside ear, or/and on the forehead under the rubber ribbon, holding the hat may be used. A display on the head will show the parameters, in order of importance as Temperature, Pulse rate, Oxygen in blood, Breath rate, Breath volume, Flow, CO2 amount, vs. O2 intake, cough rate and amplitude, obtained by adding supplementary measurement units. This unit may have a WiFi communication with cellphone, and store and or transmit data.

In hot and normal environments wearing the face mask only is not comfortable because of warming up and increase of local humidity from breathing, mostly in the cases physical effort is needed. More, the exhaled air, is warm and trends to go up, in a chimney effect, and fresh air for breathing coming from below, where is a higher probable concentration of spit aerosols, some possible carrying viruses and bacteria. Using a top fan become a first convenience, bringing an increase in safety and comfort, but makes the system more complicated.

A next step in increasing comfort is to introduce an air-conditioner unit, where the upper heat exchanger to be placed inside the hat, under the fan, and the outside heat exchanger to be in the near vicinity, on the back in a suspended enclosure to cancel compressor's vibration and noise that may become annoying. A powerful enough battery is needed to hang on the belt. To increase the efficiency will be good to collect the exhaust cooled air, and pass through outside heat exchanger, if the shield provides a good thermal insulation; else it just becomes a one more complication.

There are environments where the simple air filtration may not be enough, having volatiles and other organic compounds, and a catalytic air purifier is needed. It is made from an air fan, that pushes the air inside a duct that is part of a heat exchanger, with an optional UV light in the input. The heat comes from the air exiting the catalytic felt, that was previously warmed up, and when delivered is cooled down saving the heat by transferring to the input air. After the gas exits the heating duct is a resistor that adjusts the temperature at the right value, typically between 350-450 C depending on catalyst type.

At this temperature the viruses and bacteria are damaged, and when touch catalytic felt, that is also thermo-stabilized, they burn, transforming in carbon dioxides and water, and few other oxides. In order to assure a complete burning, more oxygen or air is introduced in the back. After leaving the catalytic felt, the heat is in part transformed in electricity in a TEG—thermo-electric generator, and the rest of almost 90% is exchanged with the intake air. Due to heat conduction and heat exchange surface issues the exhaust processed air is released warmer by 20-30 C than the ambient air, and a AC cooling is needed. This can be achieved by introducing the processed air back in the helmet, before the AC heat exchanger.

In more harsh environments, or when higher oxygen concentrations are needed, the exit from the catalytic reformer, may be introduced in a PSA (Pressure Swing Absorption) air filter, that uses a zeolite powder, to separate oxygen from nitrogen, in a push-pull compressor device, delivering up to 90% enriched in Oxygen air. This output may be introduced in a gas mixer, and create a breathable air at the desired oxygen, humidity and temperature, that may be applied directly in a full respirator mask.

In order to make the system more efficient, the expelled gas is dried, removing water by condensation, than is removing the Carbon dioxide, using an alkaline solution, usually NaOH, or a combination of cooler/compressor and chemical filter. After air is cleaned, it may be reintroduced in the air mixer to restore the desired concentrations. This added system allows one to breathe well in an environment with high methane gas or other hydrocarbon concentration up to few percent, or inside a burned gas atmosphere where the oxygen is depleted down to 1%, feature that is not commonly needed in simple bio-terrorism applications, but this is the upper limit of this device in the most complete form. In this case, previous discussed disposable gaunt, is not appropriate and an upgrade of the equipment to full PPE is recommended. One step forward is the use of bottled respiratory mixtures, technology that is already available, similar to what is used for underwater applications, as scuba diving.

### 2. Best Mode of the Invention

FIGS. 4 to 6 shows the devices in of the best mode contemplated by the inventors of the use of a personal bio-threat protection system. Its accessories devices according to the requirements are presented in FIGS. 4A and B with some solutions and developments that are embedded in the present invention.

The invention comes to bridge the gap in protection systems, from facial masks and respirators presently used, and professional PPE, full body suit, used at the other extreme, with a more compressive full body protection that to be cheap, disposable, easy to use and mass produce, delivering results similar to full body PPE, but at a fraction for the cost and better comfort, appropriately addressing the bio-hazard threat.

The invention corrects previous deficiencies of the complex process monitoring and control devices, which are bulky, hard to correlate, distributed in terrain and, improving their performances with respect to the usefulness of the data, monitoring in real time the health of the customer, and making compatible with the use of elaborated apps to predict the health and evolution based on identified symptoms.

Makes a system that warns a remote operator physician that monitors the customer when something runs out of range and is about to take an action, as a result of an undesired evolution of the controlled process, aided by simulating capabilities, and embedded “expert functions” in the computer system;

Is easy, upgradeable being modular in structure, both for breathing compositions and computer applications up to augmented reality devices to integrate more wearables on customer;

Has a ultra-light sensor applicator on operator's body structure, easy removable, and with self-control of good operation, transmitting also customer's bio-parameters related to an operator who asses the state of wellbeing;

g) Improves the warning and alert to the operator, by early detecting any anomalous evolution, based on customized data sets of the same system previously operating.

Best application of the invention is explained in FIG. 4, but it is not limited to specific application presented and there are also some applications that do not require such complex equipment, and a simplified version is possible to be used, and gradually upgraded. It may start with versions that does not anticipates the critical moments based on advanced simulation, that may bring the maximum efficiency to a customer minimizing his run outside the normal parameters.

### 3. How to Make the Invention

As one can see from the drawings this method and procedure includes a set of accessories and devices that is conceived to prevent the most complex accidents actually known, if appropriately applied.

The simplest is a set of 4 disposable gaunt, that are a paper, fabric or plasticized material sheet, to make a full head mask covering down to shoulders, that will look like a cone with flat top, having an elastic ribbon to tight on forehead, where it has a transparent surface, to enable to see outside while being air tight. On the flat top one may add a chemically impregnated in a salty solution, absorbent paper, acting as a chemical shield. One may improve the filtering using a dust filter on top, and underneath a fan, pushing air over the mouth and nose. It is at user's choice to supplementary use a face filtering mask.

The other gaunt pieces are gloves, and back half-rope, to prevent the skin contact with potential infected areas.

The most important part is the respiratory system, that may be developed in a modular fashion. If it is clear that a filter may not stop the virus flying alone to pass through, in spite the was the filters are placed, are designed to reduce probability of such encounter, and we will mention the following aspects: the intake is on top of the head, where viruses density is reducing with the exception of aerosolized viruses like Rubeola. A filter may be added, and a respiratory filter may cover mouth-nose.

More systems may be added, as AC unit, catalytic filter, oxygen filter, air mixer, and carbon dioxide extraction in a closed loop respirator, all requiring external power, but increase the user's comfort.

It is also possible to add bio-medical parameters measurement system, made of an optimized data acquisition that transmits the data to a cell phone, and from there to a computer that calculates the evolution, with anticipation, predicting the best regimes, or in the case when something bad seems to happen, it warns operators, making them aware on the issue and potential option to dodge a bad outcome.

### DETAILED DESCRIPTION OF THE FIGURES

The purpose of this work is to create a modular family of airborne viruses protective accessories for self-defense, being easy wearable, and allowing various degrees of protection depending on the gravity of the situation. The present invention starts from the characteristics of the thread agent, qualified as a bio-engineered nano-machine, bale to penetrate human tissues and inducing serious malfunctions to human body. Its propagation is performed via airborne liquid effluents, as aerosols, generated by an infected body, by sneezing or coughing, flying up to 6 to 10 m and depositing on various surfaces with a survival probability given by the environment local conditions.

FIG. 1, shows a view of the actual virus threat, starting with an electron microscope view, 101, of COVID-19 virus, one of the most advanced nano-machine in the field, having a spherical aspect with spikes, glycoprotein trimmer (S), 102, which have at least 3 freedom degrees each, that covers a nucleoprotein (N) and RNA genome, 103, covered by a membrane protein (M), 104, all having a scale, dimension, 105, or particle—magnitude, PM=0.1 micro-meters, in terms of filtering capabilities.

A corona virus diagram, 111, showing nCoV, SARS, coronavirus schematic diagram, where one may see clearer spikes, glycoprotein trimmer (S), 112, nucleoprotein (N) and RNA genome, 113, membrane protein (M), 114, with a space inside virus shell, genome, 115, creating an adaptive, morph structure.

The envelope, small membrane protein pentamer €, 116, is holding a plurality of moving spike with an outer forward move, 117 and an inner backwards move, 119, when synchronous or in waves, is driving to an effective spikes movement, 118, mowing the assembly forward or backward as a nano-motor, driven by electric and magnetic molecular potentials. From here is obvious that the virus is a nano-engineered machine, which similar to a robot, may detect water electric potential and magnetic molecular dipole and come into it, moving towards humidity.

FIG. 2, shows another simplified view of virus capabilities of penetrating human skin, shoved obvious for those understanding CoVID-19 virus, schematics, 201, and to become more obvious we tried to scale to size, 202, compared with a hair, but we failed, because, nothing remained visible from the virus structure and the ratio had not been obtained. In order to accomplish the scaling we had to replace the schematics figure with a dot, 203, just to meet the aspect ratio to match a hair shaft diameter 204, generically placed showing a view through its hair microstructure, 205.

Underneath, the hair cross section that is about 50 microns large, is placed a voxel of 2 mm size of skin structure, where the dimension correspondence, 206, to the hair shaft, 207, is made just to give a feeling of how many times the virus is smaller than the skin elements. In fact, the virus falling on skin, 235, have in fact be invisible, on this instance where it was drawn magnified by about 20 times, and similar was magnified by 10 times the watery mucus expectorated solution, 233, containing a collection of viruses 234, covering a hair shaft, and some pores, 232.

Other features of the skin, that are not compact enough, to stop the virus are, Dermal papillae, 208, covering free nerve ending, 209, sebaceous (oil) gland, 210, sensory nerve fiber, 211, arrector pill muscle, 212, hair follicle, 213, hair root, 214, that have interstices and show porosity that led the virus active nano-particle to blood vessels as artery, 215 and vein, 216.

Other elements as Meissner's corpuscle, 217, and Pacinian corpuscle, 218, and root hair plexus, 219, eccrine sweat gland, 221, placed above the adipose tissue, 220, hypodermis (superficial fascia), 222, are offering even larger spaces where the virus may rest, and survive, even multiply seamlessly extending the incubation period, while being present for lateral contamination. Therefore dermis, 224, formed from the papillary layer, 225, towards the surface and reticular layer, 223, together with epidermis, 229, comprising Stratum basale, 226, Stratum spinosum, 227, Stratum granulosum, 228, Stratum lucidum, 230, Stratum comeum, 231, pore, 232, several times larger than virus diameter, is a perfect place for Covid-19 particles, 234, thriving immersed in expectorant droplet, 233 from where they feed to diffuse towards the blood vessels, mainly veins, 216, that carries them to lungs directly, multiplying there and inducing pneumonia and breath shortness.

FIG. 3 shows microscope view of a filter or porous paper structure, and its capabilities of holding chemicals as salt crystallites bound on its structure like that used in, N95 medical filter, microscope image, 301, where one may see how large the space, 303, among celluloid fibers, 302, is compared with the dimensions of a corona virus particle, 304, flying through, having a dimension scale, 305. When virus particles are dry and flying alone, are unstoppable by dry filter configurations. Fortunately, when dry virus survival rate is low, and usually are flying inside liquid aerosols, like water droplets, 306, with corona virus contamination. These water droplets, with corona virus particle, 307, in suspension in water particulate, has high affinity for salt crystal, 308, forming a ionic saline solution that reacts with virus, damaging it, and meanwhile water is evaporating making salt recrystallize 310, trapping dead virus corps, 309, on salt's surface, locking it in place, an element of the present invention that will use absorbent materials impregnated in salts and other harmless for humans chemicals.

FIG. 4A is a view from front of head mask with chemical shields and top air intake, gloves and pants shield, warn by a customer, 401, with single use gloves with chemical shield, 403, on hands, 402, an embodiment of the present invention.

On the face and chest it wears a facial transparent shield, 406, and a frontal chemical shield, 404, with a lateral chemical shield, 405, hanged on full head mask. The mask may be sprayed outside, with salty solution to impregnate. A surgical mask may be added over the mouse, but it is not needed, because the actual full head mask protects the head and face from all directions.

For breathing purposes a ventilator, 407, drawing air from a filter with chemical stopper, 408, placed above, under a rain and air particulate cover, 409, and blowing it downwards, along the face. The air sucking on top of the head under a hard head is recommended, because in most of environments the expectorated particles are moving downwards. A battery, electronic regulator for air flow may be placed there too, and a oxygen, pulse rate, temperature, humidity ear sensor, 400, may be placed inside the cover, while a forehead electronics box with display and utilities, 410.

The problem with ppe equipment appears in the moment one wants to undress the ppe, at exit from the hazardous area, in an area that involuntary becomes contaminated. The problem occurs when the ppe is not easy, self-containing the outer surface and removable. In our case, using the regular gloves, one may remove the back skirt protection, and dispose over a box, than clean the gloves, with a disinfectant solution wet paper towel, and take off the head mask, by bending up the shoulder collars, made of chemical shield, and gently take above the head. Than over a disposable box, take out the helmet-air intake structure and clean similar to gloves, and deposit in a bag. It is warmly recommended but not a must that prior to undress an IR intense beam shower, 432, to cover the full body and accelerate the death of the viruses. The IR source, 431, on a selfie, articulated stick, 430, may be a lamp, resistor set or a flame from a torch. Adjust power and distance in order to be safe from fire, and have the surface be over 120 C where is possible—not on plastic cloths. Air spray is not recommended because it might help spreading the contamination, but vacuum pass, with special nano-bodies safe design vacuum structure may be a plus.

FIG. 4B shows a view from back of the head mask, chemical shields and respirator, and embodiment of the present invention, where a customer is viewed from behind, 411, having hands, 412, protected by a limited use protective gloves, 413, sweat proof, and impregnated in chemical shield substances. To protect against contaminants while sitting a back chemical and fluid shield, 422, is part of the set.

An air processing box, 414, placed over central back chemical shield, covered by lateral back protective shields, 415, and added an portable AC unit, 416, or a complete air preparation unit, has the top air suction over a fan and air input, 417, that takes the aspiration air through an air filter with chemical stopper, 418, under a hard, water proof cover or hat for rain and particulate protection, 419.

All portable equipment is powered from an utility and power box, 421, connected by a cable, 420, that also powers by connection the electronics box, where breathing rate and volume inhaled, exhaled is measured by a resistive cord, 423.

FIG. 5 describes a head-top modular respirator unit that is set on customer's head as a head top/hat or helmet, 501, having a head contact, 502, that allows a tight contact.

Air input, 503, for head from an exterior air supply, as air intake flow, 504, goes via air intake holes, 505, made into helmet or head-cover structure, 506, and an air labyrinth, 507, following the filter's upper lid, 508, into filtering unit containing a chemical barrier filter, 517, followed by a high MREV HEPA filter, 516, and a suction fan, 515.

In the simplest execution form, this structure pushes an airflow washing the face, 510, from up to down.

In more complex structures an air duct lower structure, 509, receives processed air from an outside unit, where optional an AC radiator for temperature control, 511, acting as a heat pump, connected by AC ducts, 514, to an outside heat exchanger. For this application the air flow going out for supplementary external preparation, 512, is following the path for air flow inside, 520, and air flow towards external air processing, 521, to exit via outlet, 512, and being returned on inlet, 503, or directly to a respiratory mask.

An electronics measurement, 518, comprising an electronics board, microprocessor and communication, 519, system integrating via WiFi the cell phone, and bio-medical parameter measurement unit with display is placed inside the helmet.

FIG. 6 shows a schematic diagram of advanced respirator unit and monitoring electronics, that takes the air from the helmet's output, as air intake, 602, coming from helmet outtake tube into air processing unit, 601, that may or may not use a supplementary fan and chemical barrier filter, 603, because one have been already used on helmet, but may be useful when one uses a facial respirator (nose-mouth), 600, stopping the viruses coming from the customer.

Air coming inside the intake heat exchanger is illuminated by an UV lamp, 604, delivering 3-4 eV photons, able to ionize Oxygen, and other organic chemicals inside. In the path through heat exchanger, 605, air temperature rises on the heating path by cooling the exit gas, 613, up to 400 C when enters input cavity, 606, where electric wires make heat adjustment before entering a catalytic felt, 607, where all organic compounds are oxidized.

In order to minimize incomplete burnout an oxygenation unit, 608, is added behind, for complete burnout, where the oxygen input, 609, is fed with air, or concentrated oxygen, 617, from oxygen generator device, 615.

Catalytic felt output, 610, is powering a thermos electric converter, in the measurement and thermalization unit, 611, where a oxygen gage is placed, via cooling heat exchanger, 612, cooling the air towards gas output, 613, where various fractions of gas concentrations are under measurement, 614, and possibly delivered to the respiration.

A PSA (Pressure swing absorption) oxygen filter, 615, may be added in order to produce 90% concentrated oxygen in air, that to be used for breathing in right mixtures in very harsh environment with low concentration of oxygen, or rich organic content that makes the catalytic felt, 607, 610, burn a lot of oxygen and depleting it. An appropriate power supply, 616, is needed to carry all consumption.

It is not a main purpose, because what we want to protect against are viruses and bacteria, in almost normal environment for healthy people helping them to stay healthy, but having an oxygen enriched output, 617, we deliver it to a breathing gas mixer, 618, recreating a near perfect atmospheric air, with no particulates, no bio-organic compounds, no other oxides as (Carbon or Nitrogen), at right humidity and pressure, at mixer output, 619, while temperature will be set into AC unit.

There is a possibility to add a specialized breathing air preparation (p, T; U) unit, 620, where AC heat exchanger to be included, together with gas parameter measurement and control unit, 621.

In order to minimize the power consumption, a carbon oxides extraction unit, 623, based on hydro-oxides chemical trapping, or a cooling compressor and reheating unit, to condensate and liquefy the carbon dioxide, or both, using the exhausted air from facial mask exhaust duct, 625, into a recirculated air exhaust with measurement, 622, and from there via a tube, 624, to facial mask air intake.

The mouth-nose facial mask, 626, may be used with this protection shield, or as part of a full body PPE (Personal protective Equipment) where the power and function of the AC unit and water condensation and recycling unit have to be extended at full body.

A set of valves and ducts are driving various configurations of gas flow inside respiratory gas processing unit, as for example, an input from catalytic burner inside carbon sequestration unit, 631, is recommended in order to further clean the input gas into oxygen concentrator and improve its efficiency, while saving energy. The respirator gas may content some disinfectants for lung, aromatic agents as in vaping therapeutically treatment, to set high customer's mood, is possible but not recommended, using input from gas/liquid external source or tube; 632.

An exit from carbon sequestration unit to oxygen concentrator unit, 633, provides oxygen concentrator with minimal gas to process, via input in Oxygen concentrator from carbon sequestration unit, 634, having a almost clean nitrogen with depleted oxygen in exhaust, preventing the use of a nitrogen tube at air preparation mixer, 632.

Because breathing is a pulsed, repetitive process, while the gas preparation is a continuous one, buffer volumes are introduced in air conditioning unit or may be added, in the forms of inflatable bags or balloons, unmarked in the schematic diagram.

A microprocessor measurement and control unit, 627, may be used to control all the functions, and have attached ambient measurement modulus, 628, and customer's bio-medical parameters measurement, 629, with all necessary electronic connections, 630.

### Examples of the Invention

The simplest application, is by using a grocery bag, put on the head, cut a window at eye level, and replaces it with transparent material, say adhesive tape, or put and stick to the paper better materials, as Plexiglas, lexane, etc., sealing them tight. Make an orifice in the top for breathing purposes, and adjust the bottom to sit on shoulders.

Impregnate the mask in salty solution, at choice (simple, deicing, Himalayan, Real Salt, etc.), by spraying, and also several absorbent paper foils and staple in the bottom side of the bag to make a skirt around. The same salty solution may be used to spray the bag outside. Care has to be taken on the type of salt used, because some of the little salt particles will be inhaled. If the salt is aggressive as deicer compounds, or is blended with bleach or hydroxides, a surgical or painter mask will be recommended to cover the mouth. This chemical layer at ph 5-7.5 is stopping the virus surrounded in watery aerosols, that dissolves the salt, making a ionic aggressive solution that chemically attacks the virus and damages it. In dry atmosphere the water evaporates, salt recrystallizes trapping the virus inside granular structure on celluloid fibers. Put a filter like on top of the bag over the vent. That will give privacy, separation of outer environment from inner environment, and over 90% protection. The total cost is in few cent ranges. To be safe, need some gloves and a half-skirt on the back for sitting on various chairs, and touching supposed previously contaminated furniture.

One may create a nicer model, in a flat tope cone, with the same chemical barrier on borders, nicer view port, and ad a picture of the face for ID purposes. On exterior a temperature sensor may be added.

The present patent is not intended to drastically change how the virus individual protection is operated, leaving in place the same control procedures, but to add a new layer of confinement based on data acquired up to now on virus propagation, leaving to user discretion how, and how long to use it.

As one may now observe is enough room in breathing air preparation, and a first step is to add a small fan, powered at a battery or solar cell, or both, with a flow regulator, to push air inside. It is recommended that any additional air filter to be placed outside, under the chemical barrier, and that may be a dust or better filter as those used in surgery masks or painting, N95 or better. This will increase the cost and weight of the mask, but will regulate the air flow, making used air be released at the lower part on the chest. The hood will still be disposable, while the fan and filters will be retained for multiple use.

For those who are looking for higher comfort, the next step is the introduction of a portable AC unit under the fan, and with proper temperature and humidity control.

If the environment seems to be more aggressive, with the presence of a large variety of gases and odors, a catalytic air preparation unit, with oxygen concentrator, and gas mixer, in a closed circuit with carbon dioxide trapping and ac adjustment is the holistic breathing protection one may acquire according to the present invention. The limitations in this environment are given by the capacity of the battery, and the volume of Carbon dioxide a chemical hydroxide unit may retain.

Bio-medical measurement systems may also be gradually developed from simple temperature, oxygen in blood and pulse-rate measurement to more complex ones, connected via wi-fi to cell phone and IoT.

1. A set of devices that reduce individual exposure to airborne pathogens, viruses, bacteria and other aggressive gas effluents comprising:
a) an impermeable to particulates head mask made of a dense fabric, as paper, plastic coated paper, textile, that is coated on exterior with saline solution and contains:
I—A visor surface made of a transparent sheet, sealed on the mask's walls;
II—A opening on top for air intake;
III—A bottom hole with enlargement to include shoulders, used for air exit;
IV—A chemical barrier made of fluffy absorbent material (paper) impregnated is salty and alkaline chemicals crystalized inside, making a chemical shield;
V—An individual facial mask preventing the breathing of large magnitude crystals;
VI—A fan on top pushing air inside the mask, preferably over eyes region;
VII—An air filter over the fan covered by a chemical shield;
VIII—A structure of ducts guiding air under the fan, and passing it through a cooling heat exchanger;
IX—An elastic ribbon inside to set tight the mask over the forehead;
X—A set of bio-medical parameters measurement including an ear clip for Oxygen, pulse-rate measurement and temperature sensor for forehead or ear, with a display outside the mask on the forehead, possibly connecting via WiFi to other devices (cell phone, computer, etc.);
XI—An optional set of ducts on top of mask allowing the connection to outside air sources;
XII—An optional heat exchanger on top over the air ducts to allow air cooling;
b)—A set of disposable gloves;
c)—A sitting foil that contents a salt barrier, a plastic foil, to be used on various surfaces;
d)—An external respiratory air supply made of:
I—An intake air duct taking air from the top of the mask air ducts
II—A catalytic air processor cleaner made of:
A)—Input Fan with filter, that takes the air from top of mask or helmet and introduces inside catalytic unit preventing accidental micro particle magnitude contamination;
B)—UV ionizer, that generates oxygen, ozone and ionizes organic effluents;
C)—Heat exchanger air heating duct, from the processed air exhaust, saving energy;
D)—Electric air temperature stabilizer, that brings the incoming air at optimum catalyst temperature;
E)—Input Catalytic felt, that makes primary oxidation of organic compounds;
F)—Oxygenation, provides excess of oxygen to perform a complete burnup, being air or oxygen from concentrator;
G)—Output catalytic felt, electric heat assisted for post-processing, that finalizes the burnout and has the right temperature to minimize nitrogen and carbon oxides;
H)—TEG electric converter, is producing electricity for maintaining the process of temperature electric stabilization;
I)—Cooling duct from intake air, saves energy transferring almost all the heat to input gas;
J)—Exhaust duct, which may be connected in various positions of the air system, most likely in the Carbon sequestration unit, if present, if not into oxygen concentrator of mask or helmet prior to AC heat exchanger;
II—An oxygen concentrator unit, with dual output made of:
A)—An input duct, which may be connected to the catalytic exhaust or to carbon sequestration unit exhaust, most likely when this module is present;
B)—A regular portable PSA unit having an output for concentrated Oxygen and another for depleted oxygen gas;
C)—A output ducts going to air mixer;
III—A carbon oxides retention unit made of:
A)—An optional compressor, cooler to obtain liquefied carbon dioxide;
B)—Followed by a chemical carbon oxides capture chemical hydroxide (Na, Ca) filter, most likely only the chemical unit will be present;
C)—An output duct that may drive to oxygen concentrator or to air mixer;
IV—A air mixer unit to prepare respiratory gas, used when oxygen concentrator is present or is an outside gas/liquid bottle, that may be mixed in respiratory air;
V—An AC unit doing, doung air conditioning before being returned to mask or full respiratory unit;
e)—A portable power supply, to power all electric system
f)—An electronics unit to centralize the command and communication of the system

2. A set of devices according claim 1, where the mask may be made from a disposable lateral surface and a helmet on top, containing the electronics, ducts and AC functions, designed for longer usage.

3. A set of devices according claim 1, where the customer may use a personal facial filter or a an external unit for respiratory gas preparation.

4. A set of devices according claim 1, where the customer may use it in explosive gas environments containing Methane up to 4%, without need to use bottled oxygen, when using full configuration of respiratory gas processing unit, with the condition of changing the suits materials to match the anti-ex conditions, and checking for toxicity compatibility of equipment.

5. A set of devices according claim 1, where the customer may use it in depleted oxygen environments, down to 3% residual oxygen, as fires, burned gas, with the condition that checks the full compatibility with environment.

6. A set of devices according claim 1, where customer may use the mask only without the top air processing and fan unit, nor the external unit.

7. A set of devices according claim 1, where the customer uses a bio-medical monitoring unit connected to local microprocessor and remote.

8. A set of devices according claim 1, where the customer displays permanently his well-functioning of vitals, and his health state on the display on the face mask and on remote devices.

9. A set of devices according claim 1, where the customer may select the chemical compositions of the salts he is using on chemical shields with full responsibility of consequences.

10. A method to reduce individual exposure to airborne pathogens, viruses, bacteria and other aggressive gas effluents that a light fabric mask impregnated with saline and/or alkaline solution solid crystalized on comprising the following actions:
a)—Take the new protective head mask, and impregnate interior and exterior by spraying with warm, saturated saline solution, of a good brand, because some salty aerosols will be subject to inhaling;
b)—Impregnate the external absorbent paper shield in any kind of salty solution that is not hazardous for breathing, may contain bases in low concentration;
c)—Put the gloves on hands if the mask or any component is reused;
d)—If one buy it new, or prepare himself, take the mask and install over the head; those who use the external air system in helmet configuration, attach the protective mask on helmet and helmet on the head, such as to cover the shoulders too, and connect the air hoses and cables; while those who uses the simpler version, just set the head mask on the head tight enough.
d)—Assure that the electronics monitoring the health and communication is in the right position and working properly;
e)—Connect all air ducts from helmet to air preparation unit, cabled from battery and monitoring electronics, and start all processes inside, check that are working proper and load the equipment in the backpack, with chemical barrier protection over;
f)—Grab the sitting half-rope, and install, or hold in pocket, or backpack;
g)—Enter the contaminated zone, and perform the required action;
h)—Monitor all the time equipment and bio-medical operating parameters, and leave the zone in case of malfunction;
i)—After leaving the contaminated/hazardous zone, go to undressing bay, and start the undressing procedure, carefully to minimize cross contamination;
k)—Take the steam, UV air shower on full body starting from top to bottom;
l)—Remove air preparation backpack, and dispose the chemical shield cover/protection sheet;
m)—Wash gloves and dry, or remove and pick new gloves, if a dual pair was not initially loaded on hand;
n)—Remove the helmet or head protection, and dispose the single use chemical shield;
o)—Set the reusable items in specialized store boxes for the next operation;
p)—Dress off the other cloths that have been exposed to contamination and treat them as contaminated, keep away from clean streams.
q)—Place everything ready for next action.

11. A method to reduce individual exposure to airborne pathogens according to claim 10, where chemical salts are used to create by crystallization a shield for viruses that thrive in liquid particulates, that stop on the impregnated fabric, locally dissolves it, as the salt ions react with virus deactivating or destroying it and incorporating it into the dried salt.

12. A method to reduce individual exposure to airborne pathogens according to claim 10, where an external respiratory gas is produced clean by using, heat, optical ionization and catalyst to burn and react all organic aerosols, reducing them to basic components.

13. A method to reduce individual exposure to airborne pathogens according to claim 10, where, the protective equipment is removed prior to an IR shower.

14. A method to reduce individual exposure to airborne pathogens according to claim 10, where before undressing the protection an Infra-Red or steam shower is applied.

15. A method to reduce individual exposure to airborne pathogens according to claim 10, that uses disposable, cheap gaunt, to prevent contamination.

16. A method to reduce individual exposure to airborne pathogens according to claim 10, that a user may use a complex catalytic burner, carbon sequester, oxygen concentrator and respiratory air preparer and conditioning unit to feed a full face respirator mask.

17. A method to reduce individual exposure to airborne pathogens according to claim 10, where one may use a bio-medical data acquisition system, displaying on forehead of the face mask the health status and main parameters.

18. A method to reduce individual exposure to airborne pathogens according to claim 10, where the user may use the bio-medical data in conjunction with anticipative software on remote computer to predict the health evolution.

19. A method to reduce individual exposure to airborne pathogens according to claim 10, where the customer is using a natural salt at his choice to impregnate the inner side of the head mask.
